(19) United States
(12) Patent Application Publication
(10) Pub. No.: US 2013/0288207 A1
(43) Pub. Date: Oct. 31, 2013

(54) Method of Preparing Letter Art

(71) Applicant: Jed Murdock Ostrom, Ithaca, NY (US)

(72) Inventor: Jed Murdock Ostrom, Ithaca, NY (US)

(21) Appl. No.: 13/457,992

(22) Filed: Apr. 27, 2012

(51) Int. Cl. G09B 11/00

(52) U.S. Cl. 434/81

(57) ABSTRACT

A method of creating and manipulating Letter Art, allowing a user to create unique Letter Art by individually changing visual elements of the letters.

### BACKGROUND OF THE INVENTION

1. Field of the Invention

The invention pertains to the field of methods of computer generation of type font characters. More particularly, the invention pertains to creation of letter art by transforming stored characters into artwork.

2. Description of Related Art

Letter Art is a drawing, painting or sculpture with a particular composition (placement or arrangement of visual elements or ingredients) that arranges the visual elements to create a recognizable letter, string of letters or word. FIG. 1 shows a letter art example of a capital J in the English alphabet, in which the letter 101 forms the body of a robot-like character with a helmet, goggles, crawler treads, and so on.

The process of creating and customizing Letter Art has been around for a long time. Previously, an artist would be commissioned with the task of manually creating the Letter Art based on a specification. This process was often very time consuming and costly, and the resulting work of art was on paper, canvas, bronze, stone and other media. Manipulating areas of the composition during the creation process and after the work of art was completed according to the specification is very difficult and time consuming, if not completely impossible.

With recent technological innovations in software development, applications have emerged that provide a person a much easier path to create and customize Letter Art. For example, some web sites have allowed users to choose a general style for letters, typically in the form of a name, and then the name is rendered in the style and physically mailed to the customer. The individual letters in the name may be preloaded from letters stored as digital images, or actually created by a human artist using a computer program or even pen and ink. The user is limited to choosing predetermined styles or images, or in instructing the artist as to how they want the result.

The creation of Letter Art thus still requires a the skills of a highly experienced artisan, and the manipulation of a piece of created Letter Art, e.g. changing the hue, saturation, brightness, texture, shape and size of a specific area within a single letter of a word, requires a particular level of skill and experience using the existing software tools available.

### SUMMARY OF THE INVENTION

The invention presents a method of creating and manipulating Letter Art, allowing a user to create unique Letter Art by individually changing visual elements of the letters.

### BRIEF DESCRIPTION OF THE DRAWING

FIG. 1 shows a single letter rendered in Letter Art.

FIGS. 2a and 2b show how individual visual elements are combined to make up a letter for use with the method.

FIG. 3 shows a flowchart of the method.

FIG. 4 shows an example of a computer screen display for manipulating the elements of a letter using the method.

FIGS. 5a to 5c show how a single letter can be varied using the method.

FIGS. 6a to 6c show how visual elements are combined using adjoining layers of differing color.

FIGS. 7a to 7c show how visual elements are combined using overlapping layers of differing color.

FIGS. 8a to 8d show examples of letter art, illustrating a range of different letter art styles usable with the method.

### DETAILED DESCRIPTION OF THE INVENTION

It will be understood that where the terms “letter” or “character” are used herein, the terms are intended to be synonymous and mean “any typographical character including alphabetic letters (upper or lower case), numbers, punctuation, special characters, or any sort of foreign-language letters or characters.”

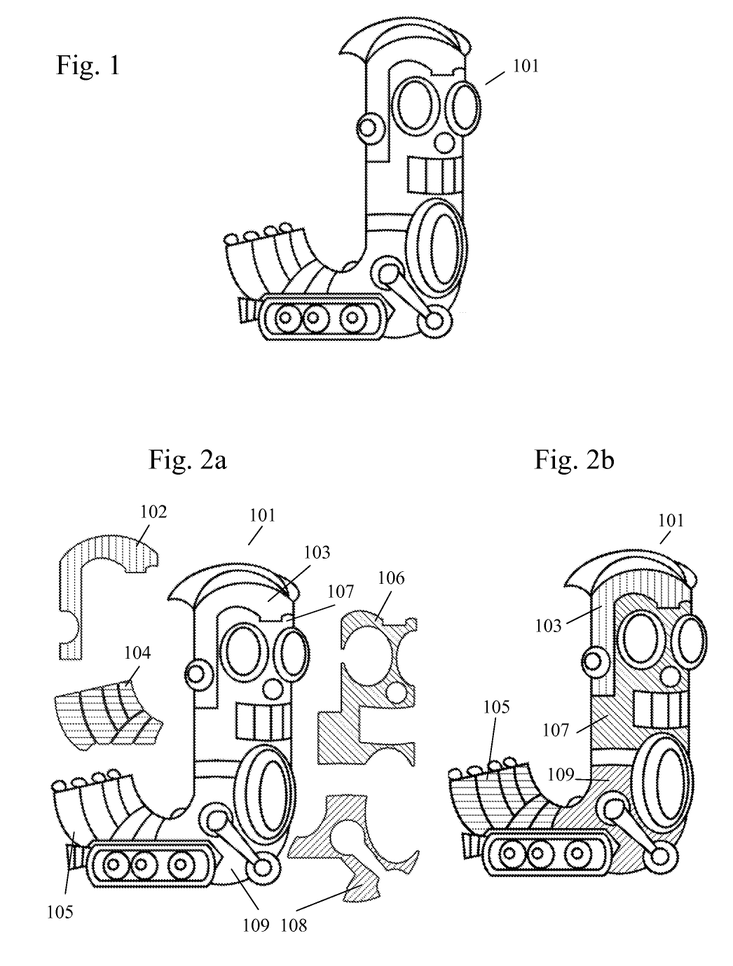

FIG. 1 shows a capital-J as it might be rendered as Letter Art as a simple line drawing. In practice, though, Letter Art is preferably rendered in colors.

Separate areas or visual elements are created as shown in FIG. 2a to fit into some or all of the open areas in the letter 101 shown in FIG. 1. Red element 102 fits into the defined area 103 on the letter 101, representing hair or a helmet. Similarly, the green element 106 is for the face area 107, brown element 108 fits on the body area 109, and blue element 104 fits in the tail area 105.

FIG. 2b shows the same letter J 101, with the visual elements 102, 104, 106 and 108 overlaid into the corresponding areas of the letter 101. This results in the hair or helmet 103 being red, the face 107 green, the body 109 brown, and the tail 105 blue. Of course, it will be understood that while the visual elements are lined for specific colors, the lining in the drawings is for example only and is not meant to limiting. Any color or combination of colors or textures or shading can be used on the visual elements within the teachings of the invention.

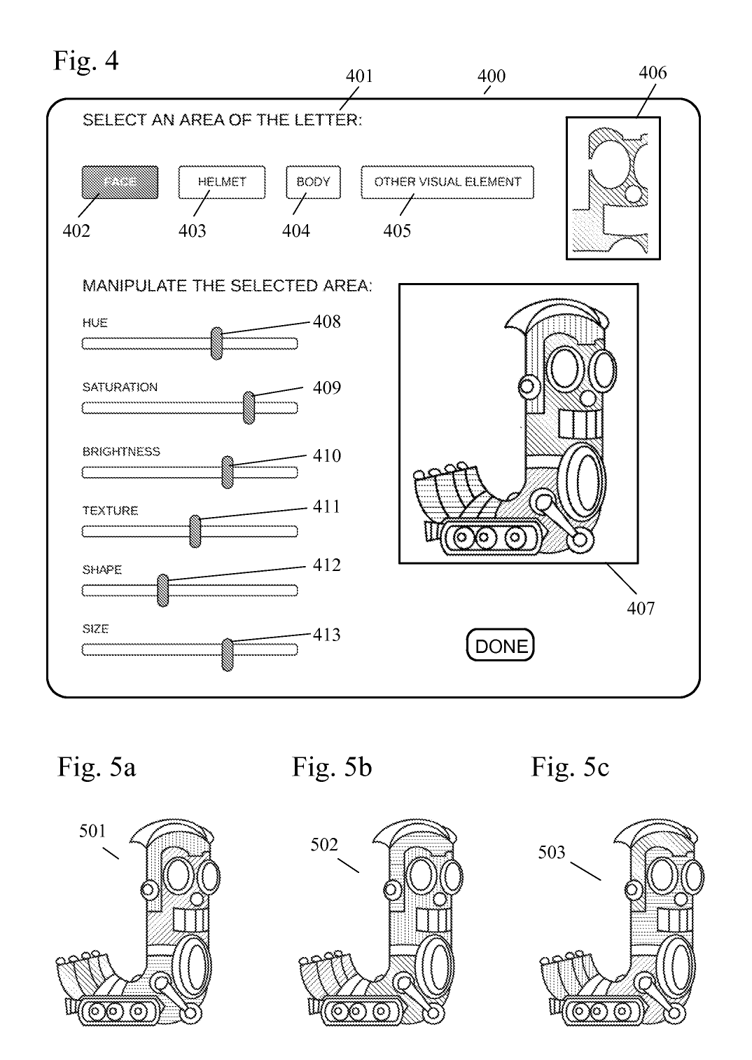

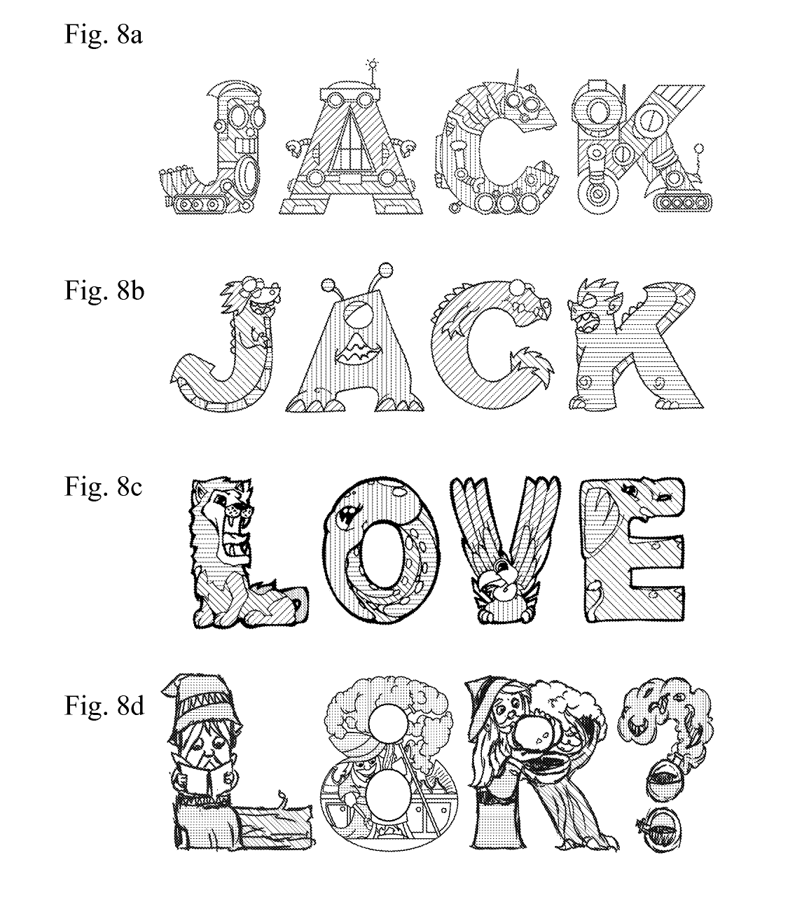

FIG. 4 shows a simulated screen display 400 which might be used with the method. In the example, the user has previously decided upon a “robot” theme for his Letter Art, and has entered the name “JACK”, as shown in FIG. 8a.

If he had chosen a “mythical animals” theme, the name might be rendered as in FIG. 8b. FIG. 8c shows the word “LOVE” rendered in an “exotic animals” theme. FIG. 8d shows how the Letter Art can include numbers and punctuation and other special characters, rendering the string “L8R?” in a “wizards and magic” theme. As can also be seen in FIG. 8d, the visual elements of the letters are not limited to body parts or clothing, but could include other areas such as the log forming the horizontal stroke of the “L”, or the smoke in the “8” and question mark. It will be understood that the Letter Art in FIGS. 8a-8d are given for example purposes only, and other words can be rendered using other themes within the teachings of the invention.

Having entered the name to be rendered as Letter Art, the user now has chosen to vary the appearance of the letter J. Once again, the letter J is the one shown and discussed above, but it will be understood that this is just to be consistent for example purposes, and other letters and visual elements would be encompassed within the method.

The screen display 400 shows the letter to be rendered in a window area 407. An area of the screen 401 would permit selection of a visual element or letter area to be adjusted—here this is shown as button 402 for the face, 403 for the helmet, 404 for the body and 405 for “other visual element” (in this case, the tail). The user has selected button 402 to load the face visual element into a window 406 and allow manipulation of that element.

The method then allows varying characteristics of the visual element to change the appearance of the letter. In the example on screen 400, this is implemented as sliders to change hue 408, saturation 409, brightness 410, texture 411, shape 412 and size 413. In a manner common to many picture editing programs, the user can pick a slider by clicking it with his mouse, and then move the slider from side to side to vary the characteristic along a continuum from one value to another.

For example, hue slider 408 might be moved from red on the left-most position through orange, yellow, green and blue, to violet on the right-most position. Saturation slider 409 could be moved from 0% saturation (grayscale) on the left to 100% saturated colors on the right, and brightness slider 410 could be moved from black (no brightness) on the left to full brightness on the right. Using these three sliders, then, any desired color could be chosen for the selected element in window 406.

By using slider 411, a texture could be imposed upon the visual element. For example, this slider might go from completely smooth on the left through various textures at different points on the slider. Alternatively, the method might offer a way of selecting a texture from a menu or the letter style might have predefined textures for each visual element, and the slider selects how much of the texture is applied. For example, the “face” visual element selected in the example might be defined as having a “facial hair” texture, and the slider could be moved from clean-shaven through full beard. The “helmet” could be defined as having a metallic texture or hair, or the body might be defined as having a rough cloth-type texture, and so on.

The shape and size of the element could be varied in a similar fashion using sliders 412 and 413.

The mechanics of creating these variations are common to many imaging programs of the prior art, and do not form part of the invention.

The changes to the element in window 406 could be simultaneously reflected in the letter in window 407, or the letter could be left unchanged as a comparison until the user confirms his selected variations, then the updated visual element could be copied into the predefined location in the letter in window 407.

The user could then move on to vary other visual elements, or go back to select another letter in the word or phrase.

FIGS. 5a through 5c show the example letter J in three different variations. For example, letter 501 in FIG. 5a has red hair, a brown face, a blue body, and a green tail. Letter 502 in FIG. 5b has blue hair, a red face, a green body, and a brown tail. Letter 503 in FIG. 5c has green hair, a blue face, a brown body, and a red tail. Of course, other colors are possible within the teachings of the invention.

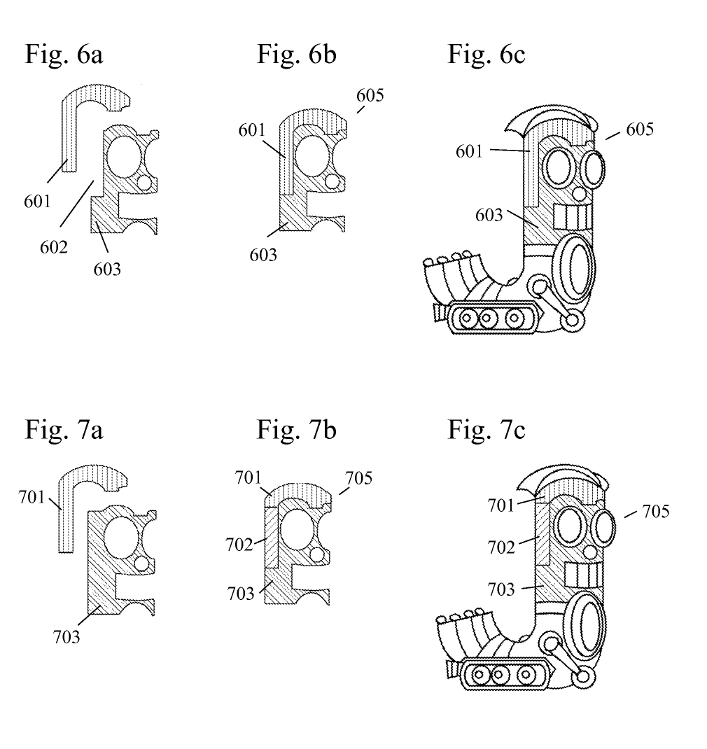

FIGS. 6a to 6c show the combination of visual elements such as helmet 601 and face 603, in an embodiment in which elements do not overlap. These figures are consistent with the example elements shown in FIG. 2a. In this case, as can be seen in FIG. 6a, a cut-out 602 is provided in face element 603 where the helmet would overlay the face 603. When the helmet 601 and face 603 are combined into the letter 605 (FIG. 6b), the red helmet 601 and green face 603 do not interact, and the helmet element 601 remains completely red as it is overlaid into the letter 605.

FIGS. 7a to 7c show an alternative embodiment where the colors of the visual elements (and possibly other visual qualities) are permitted to overlap and combine. In this embodiment, as can be seen in FIG. 7a, the green face 703 is complete, with no cut-out for the red helmet 701 as was provided in the embodiment of FIG. 6a. Thus when, in FIG. 7b, the red helmet 701 is overlaid on the green face 703, there is an area where a portion of the helmet and a portion of the face combine to form a brown area 702, assuming that the method is set up to use pigment combinations, which is probably the most intuitive system for most people. Alternatively, it could be set to use light combinations, then the overlap of the red and green would produce a yellow area, or any other combination logic could be implemented within the teaching of the invention. The effect of the combination could optionally be controlled by varying the transparency of the top layer in the combination.

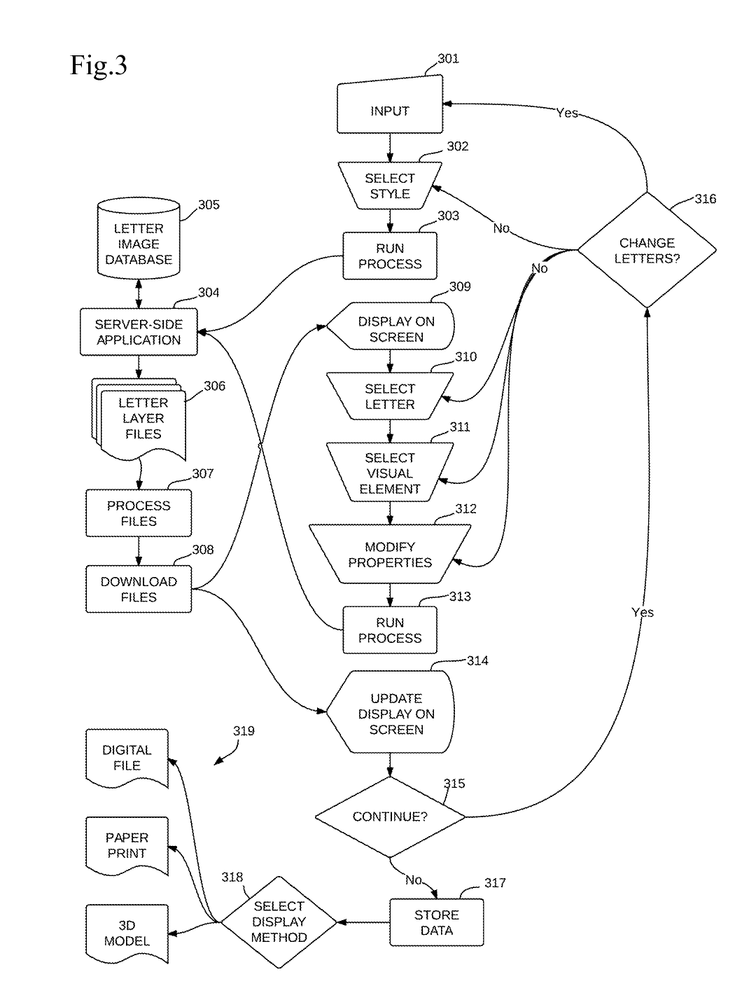

FIG. 3 shows a flowchart of an embodiment of the method of manipulation of a piece of Letter Art for final display.
301. The person enters a letter or string of letters into a text input field. The string could be a word, a name, a phrase, or any other text the person wishes to have rendered as Letter Art.
302 The person then selects from a list of styles offered as a pull-down menu, selection buttons, ordered list, sample letters or other means known to the art.
303. Optionally, a process is run which communicates to a server-side application 304. Alternatively, this step can be performed as a stand-alone application on the person's computer. The application reads from a letter image database 305 to prepare a group of letter image files 306 for each of the chosen letters in the string. Each letter image file represents an alphabetic character (letter, number, punctuation, etc.) having a number of visual elements associated with it to be overlaid upon the character in defined locations.
307. The letter image files are processed to initialize the visual elements with initial pre-determined visual properties settings including, for example, hue, saturation, brightness, texture, size and shape. The visual elements are overlaid on letter images from the letter image database 305 to produce initial Letter Art letter files.
308. The processed Letter Art letter files are downloaded to the person's computer running the application.
309. The Letter Art letter files are arranged on the screen to make up the composition of each letter in the string that was originally input.
310. The person can now select a letter. Alternatively, the selection of a group of letters could be implemented, so that the user can make corresponding changes to corresponding elements (i.e., faces, hair, etc.) of each of the letters in the group simultaneously.
311. The person selects a visual element from those which make up the letter.
312. The person modifies the properties of the visual element, as explained in the discussion of FIG. 4, above.
313. Upon modification, the modified letter image is produced. This may be done by running the process again to take the letter layer files 306, process the modification made by the person in step 312 on the letter layer files, insert the letter layer files into the Letter Art letter file, and download the Letter Art letter file back to the person's computer. Alternatively, the modified letter could be produced by modifying the letter image already in memory, without further reference to the database.
314. The display of the letter or string of letters is updated on the person's computer screen.
315. At this point, the person can choose if he wants to continue modifying the Letter Art or not. If he chooses to continue, the process continues on to step 316. If not, it passes to step 317.
316. The user will have to choose what he wants to do next, and the method will proceed to the numbered step:
301. To enter a different string or modify the string of letters previously entered.
302. To select a different style for the same string.
310. To select a different letter to modify.
311. To select a different visual element to modify.
312. To select a different visual property of the selected visual element to modify.
317. The data is stored for future use, either on the present computer or some other computer.
318. If the person has chosen not to continue with modification—he is content with the Letter Art he has designed—then, optionally, he can choose an output method 319 for his Letter Art. These choices could be to create a digital file, print the Letter Art on paper, or to make a 3D model for example by printing the letter art on a rapid-prototyping 3D printer.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of creating letter art from a letter image database having a plurality of letter images in a plurality of styles, each letter image comprising a letter having an associated plurality of visual elements to be overlaid upon the letter in defined locations, each visual element having at least one visual property, the method comprising the steps of:
a) accepting a string comprising a plurality of letters from a user;
b) accepting a selection of a style from the user;
c) retrieving a plurality of letter images from the letter image database, the letter images representing each of the plurality of letters in the string in the selected style;
d) processing the plurality of letter images to form processed letter images by initializing at least one visual property of each of the plurality of visual elements associated with each of the letter images; and overlaying each of the initialized visual elements on the associated letter image;
e) combining the processed letter images for each of the letters in the string into a work of letter art and displaying the work of letter art to the user;
f) accepting a selection of a letter in the string from the user;
g) accepting a selection of a visual element associated with the selected letter from the user;
h) accepting a variation in at least one visual property of the selected visual element;
i) applying the variation in the at least one visual property to the selected visual element to produce a modified visual element;
j) inserting the modified visual element into the letter image for the selected letter to produce a modified letter image;
k) displaying the string to the user with the modified letter image; and
l) continuing the method from step f.

2. The method of claim 1, in which in step (b) the user indicates the style selection by choosing from a list of styles offered as a pull-down menu.

3. The method of claim 1, in which the at least one visual property is selected from a group consisting of hue, saturation, brightness, texture, size and shape.

4. The method of claim 1, further comprising the step of outputting the work of letter art.

5. The method of claim 4, in which the step of outputting comprises saving the work of letter art as a digital file.

6. The method of claim 4, in which the step of outputting comprises printing the work of letter art as a printed image.

7. The method of claim 4, in which in which the step of outputting comprises printing the work of letter art as a 3D model.

8. The method of claim 1, in which step (f) of selecting a letter further comprises selecting additional letters, and the selection of a visual element in step (g) selects corresponding visual elements in all of the selected letters, such that the user can simultaneously make changes to a selected group of letters.

9. The method of claim 1, further comprising the step of storing the letter image.
